(19) United States
(12) Patent Application Publication
(10) Pub. No.: US 2004/0260003 A1
(43) Pub. Date: Dec. 23, 2004

(54) Anti-abrasive fire retardant composition

(76) Inventor: David E. Tweet, Eden Prairie, MN (US)

Correspondence Address: NAWROCKI, ROONEY & SIVERTSON, SUITE 401, BROADWAY PLACE EAST, 3433 BROADWAY STREET NORTHEAST, MINNEAPOLIS, MN, 554133009

(21) Appl. No.: 10/469,262

(22) PCT Filed: Feb. 26, 2002
(86) PCT No.: PCT/US02/06012

(51) Int. Cl. C08K 3/04; C08K 5/49

(52) U.S. Cl. 524/495; 524/115

(57) ABSTRACT

Several general embodiments of an anti-abrasive fire retardant composition are provided, namely those comprising a plastisol binder, a polyurethane modified plastisol binder or system, or a pure urethane system modified to induce fire-retardancy. Preferably, the instant compositions of the subject invention are characterized as including a phosphate ester plasticizer, and further optionally including, alone or in combination, metallic compounds or intumescent graphite flake. It is likewise contemplated to include/incorporate (e.g., bind) ceramic (Al₂O₃) chips into base formulations of the subject invention to greatly enhance the abrasive character of the resulting composition or panels so fabricated.

### TECHNICAL FIELD

The present invention relates to anti-abrasive fire retardant compositions, more particularly to plastisol or urethane elastomer systems which may include effective amounts of fire retardant plasticizers, metallic compounds, ceramic elements and/or char forming graphite, the compositions being especially well suited for wear applications, such as lining material handling equipment and the like.

### BACKGROUND OF INVENTION

The grain and fertilizer industries contend with ten to twenty fires every year in the United States alone. Abrasive liners or panels for use in grain exchange, and other material handling equipment, is an economic necessity. Although it is particularly desirable that liners and the like posses a degree of resiliency for improved durability, such compositions lack sufficient fire retardant properties, with some product formulations actually fueling the fires and otherwise contributing to the unsafe conditions associated therewith. Heretofore know “fireproof” liners for material handling equipment include nickel hardened steel and ceramic tile, each of which suffers from unique shortcomings.

Nickel-hardened steel, alleged to be non-burning, lacks an acceptable level of abrasion resistance, particularly when compared to available and widely used urethane elastomer products, such as Rhino-Hyde® and Kryptane®, and ceramic tiles. Aside from other economic considerations, the cost associated with maintenance and replacement of nickel hardened steel, let alone the “cost” of equipment and processing down time, is overly burdensome for the majority of material handling applications.

As to the ceramic material available for liner tiles, it is especially brittle, being particularly susceptible to chipping and breakage when directly affixed to a rigid structural substrate, as is almost always the manner in which such tiles are utilized in material handling applications. Premature tile failure frequently occurs in material handling applications where, in addition to surface sliding, surface impacts are present.

Since the mid-1960s, the abrasion resistant characteristics of urethane elastomers have been employed to make elastomeric lining materials (i.e., chute lining elastomers) to protect the equipment of companies that handle large volumes of dry or slurry-bulk abrasive materials. Although such elastomeric lining materials, which generally lack the supreme abrasion resistance of ceramic material, combine sufficient abrasion resistance with advantageous impact cushioning, they, by their very nature, are known to contribute fuel to the very fires that the industry seeks to reduce and eliminate. The grain feed and flour milling industries have desired a fire-retardant urethane composition suitable for lining bulk handling equipment for upwards of twenty years.

Urethane elastomer systems can be made fire retardant by the incorporation of massive amounts of a fire retarding additive agent, such as aluminum tri-hydrate. The amount of such fire retardant additive agent typically and prohibitively approaches, and often times exceeds, fifty weight percent of the total composition. Adding fifty percent of an inert, non-performing raw material makes the polymer almost impossible to handle without the abrasion resistant characteristics normally associated with urethane elastomeric products. Needless to say, the advantage of improved fire retardation at the “cost” of reduced or diminished abrasion resistance was not a viable solution, and as such was not well received.

Incorporation of ceramic material into known urethane elastomer formulations has met with limited success, and has yet to approach anything commercially practicable. Although the presence of the ceramic material in the composition is intended to enhance the abrasion resistant character of the composition, and commensurately reduce, on a weight percentage and therefore a real mass basis, the amount of urethane elastomer available as a fuel and smoke source should a fire occur, heretofore known urethane elastomer formulations have had limited ceramic load capabilities.

Further complicating a “solution,” whether it be by addition/substitution of alternate fire retarding agents to an otherwise acceptable abrasion resistant material, or otherwise, is the constraint of Food and Drug Administration (FDA) approval for material handling liners, and the like, for use in grain handling and flour milling operations. Thus there remains a need for anti-abrasive fire retardant compositions (i.e., a fire stop composition) suitable for material handling applications, more particularly, an abrasion resistant urethane elastomer system which is fire retardant and non-flowing when subjected to an open flame.

### SUMMARY OF THE INVENTION

Several general embodiments of an anti-abrasive fire retardant composition are provided, namely those comprising a plastisol binder, a polyurethane modified plastisol binder or system, or a pure urethane system modified to induce fire-retardancy. Preferably, the instant compositions of the subject invention are characterized as including a phosphate ester plasticizer, and further optionally including, alone or in combination, metallic compounds or intumescent graphite flake. It is likewise contemplated to include/incorporate (e.g., bind) ceramic (Al₂O₃) chips into base formulations of the subject invention to greatly enhance the abrasive character of the resulting composition or panels so fabricated.

More specific features and advantages will become apparent with reference to the DETAILED DESCRIPTION OF THE INVENTION, appended claims, and the accompanying drawing figures.

### BRIEF DESCRIPTION OF THE DRAWINGS

TABLE 1, Test Summary: Illustrative Composition Formulations v. Controls, provides a summary of performance test data for the listed composition formulations and controls;

TABLES 2-7, Illustrative Composition Formulations, provides a listing of composition constituents for the tested composition formulations;

TABLE 8, Physical Properties, provides a listing of select physical properties for the compositions of TABLES 3-7 relative to ultrahigh molecular weight polyethylene;

FIGS. 1A-1C depict heat release rate, specific extinction area, and carbon monoxide, respectively, as a function of time for the urethane 5.1 control;

FIGS. 2A-2C depict heat release rate, specific extinction area, and carbon monoxide, respectively, as a function of time for the urethane 5.2 control;

FIGS. 3A-3C depict heat release rate, specific extinction area, and carbon monoxide, respectively, as a function of time for the ultra high molecular weight polyethylene control;

FIGS. 4A-4C depict heat release rate, specific extinction area, and carbon monoxide, respectively, as a function of time for illustrative composition formulation 1;

FIGS. 5A-5C depict heat release rate, specific extinction area, and carbon monoxide, respectively, as a function of time for illustrative composition formulation 1C;

FIGS. 6A-6C depict heat release rate, specific extinction area, and carbon monoxide, respectively, as a function of time for illustrative composition formulation 21;

FIGS. 7A-7C depict heat release rate, specific extinction area, and carbon monoxide, respectively, as a function of time for illustrative composition formulation 21C;

FIGS. 8A-8C depict heat release rate, specific extinction area, and carbon monoxide, respectively, as a function of time for illustrative composition formulation 22; and,

FIGS. 9A-9C depict heat release rate, specific extinction area, and carbon monoxide, respectively, as a function of time for illustrative composition formulation 22C.

### DETAILED DESCRIPTION OF THE INVENTION

Several general embodiments of the subject anti-abrasive fire retardant composition are to be presented, namely those which comprise a plastisol binder, a polyurethane modified plastisol binder or system, or a pure urethane system modified to induce fire-retardancy. It is likewise contemplated to include/incorporate (e.g., bind) ceramic (Al₂O₃) chips into base formulations of the subject invention to greatly enhance the abrasive character of the resulting composition or panels so fabricated. Specifics of this composition feature will be subsequently developed.

Regarding the plastisol binder, a basic plastisol formulation is preferred in which a high performance polyvinyl chloride (PVC) dispersion resin is combined with fire-retardant plasticizers, preferably but not necessarily FDA approved plasticizers. Advantageously to the aforementioned plastisol, metallic compounds may be added in effective amounts to more greatly attain the sought after fire stop qualities. For instance, a borax (i.e., zinc borate) fire retardant powder may be added up to a concentration of about 15 wt %. Furthermore, an aluminum trihydrate may be added to the basic plastisol formulation to a concentration of up to about 25 wt %. Finally, both borax and aluminum trihydrate may be added up to a total concentration of about 30 wt % of the basic plastisol formulation.

With regard to the polyurethane modified plastisol system, the aforementioned four plastisol base formulations can be modified with a urethane elastomeric system. The basic principle is to add the polyol portion of the urethane system to the above plastisol formulations. Prior to product use, the pre-polymer is then added to the modified plastisol and the process to manufacture the product proceeds as in the case of the plastisol. In this scenario, the polyol used to cure the urethane pre-polymer also functions as a plasticizer and becomes an integral part of the cured plastisol system. The level of urethane modification can be up to 50 wt %. The greater the concentration of urethane modification, the greater the tendency of the product to drip on burning and the less fire-retardant the system becomes, however, the abrasion resistance of the product is significantly improved.

Finally, a pure urethane system, such as those commercially available from Tandem Products, Inc., Minneapolis, Minn., USA, namely their line of Rhino Hyde® products, may be modified to induce fire-retardancy. Preferably, a high performance abrasion resistant urethane elastomer system may be modified via the introduction of an expandable char forming graphite material. Further still, fire retardant plasticizers may be included, more particularly, the urethane elastomeric system may be modified with the fire retardant plasticizers and the inclusion one or more metallic compounds (e.g., borax and/or aluminum trihydrate). Processing of such compositions proceeds as previously outlined, however, the cure is completed at approximately 200-250° F. rather than at about 400° F.

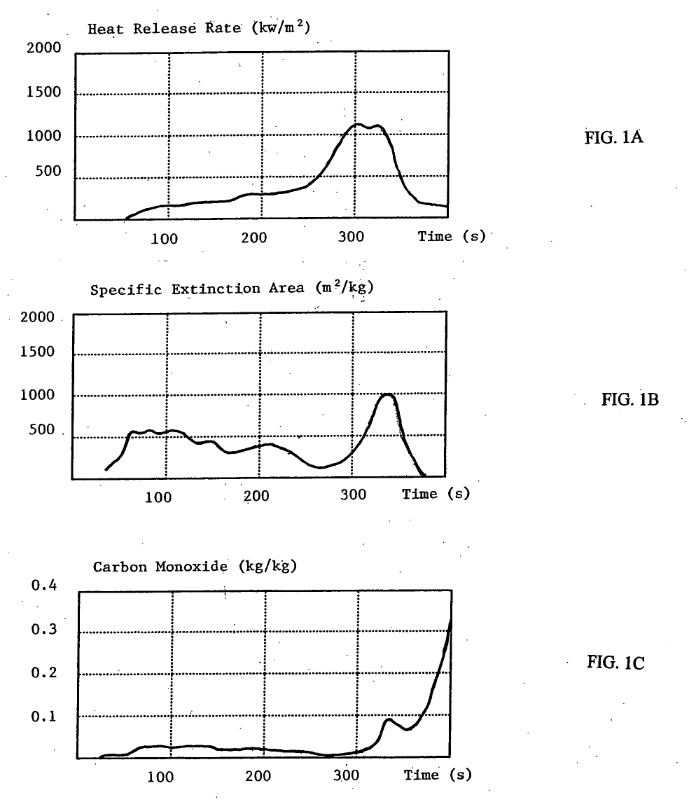

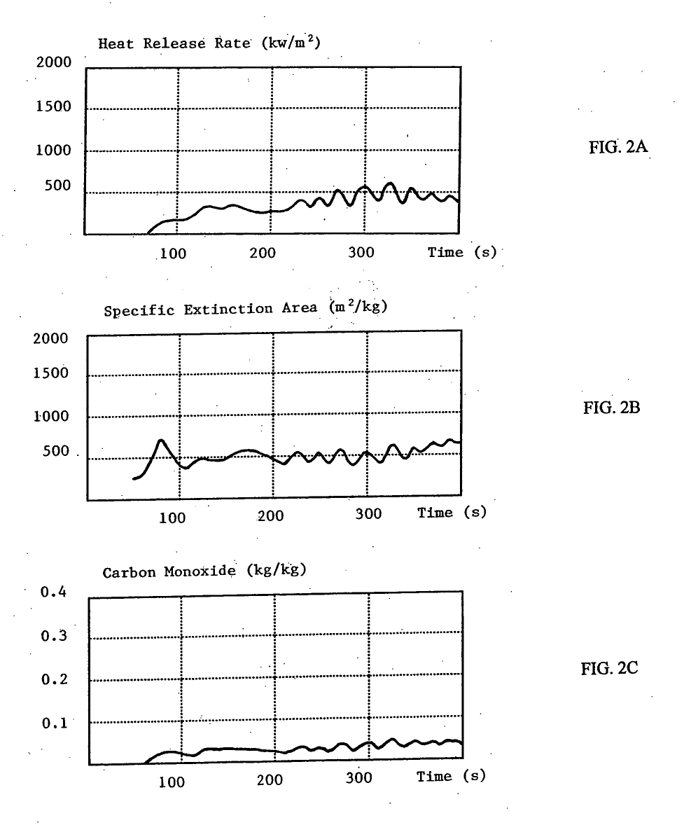

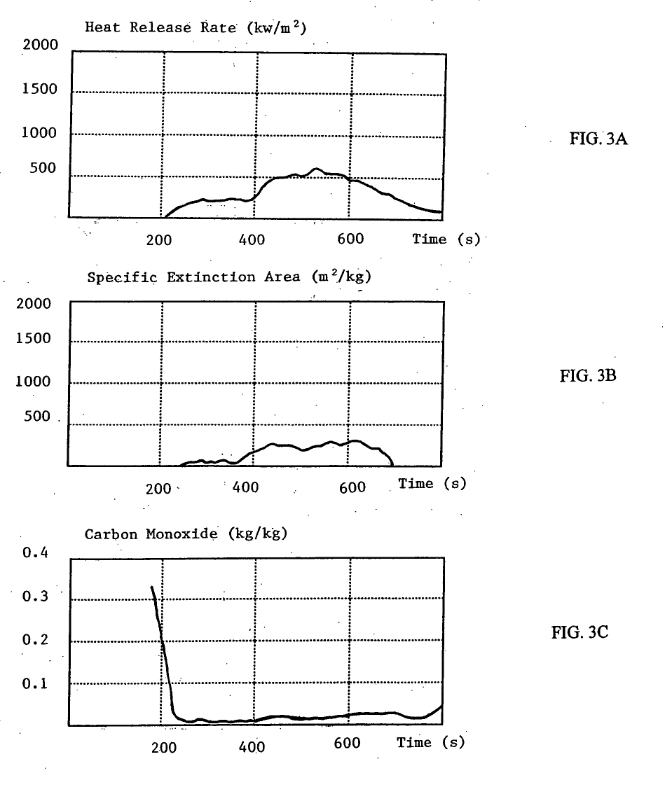

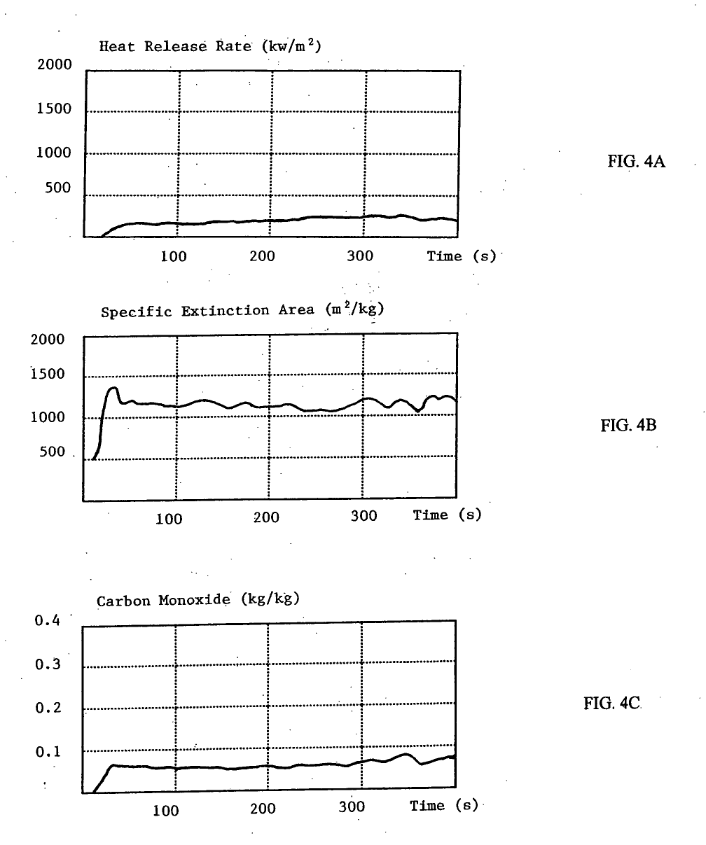

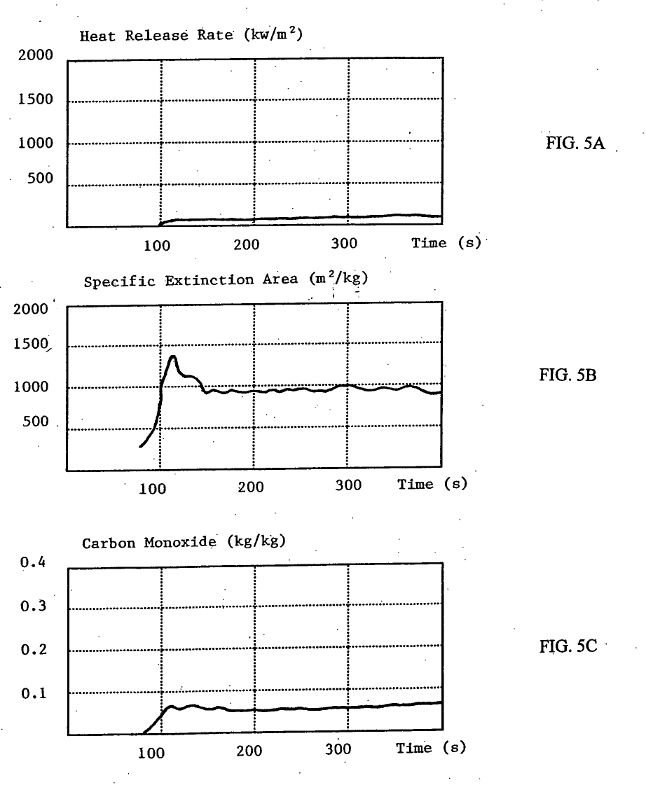

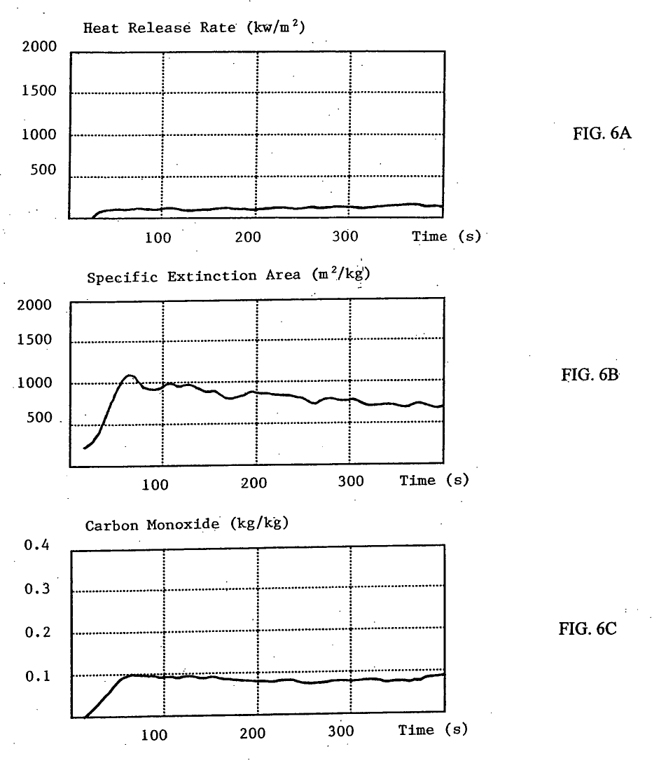

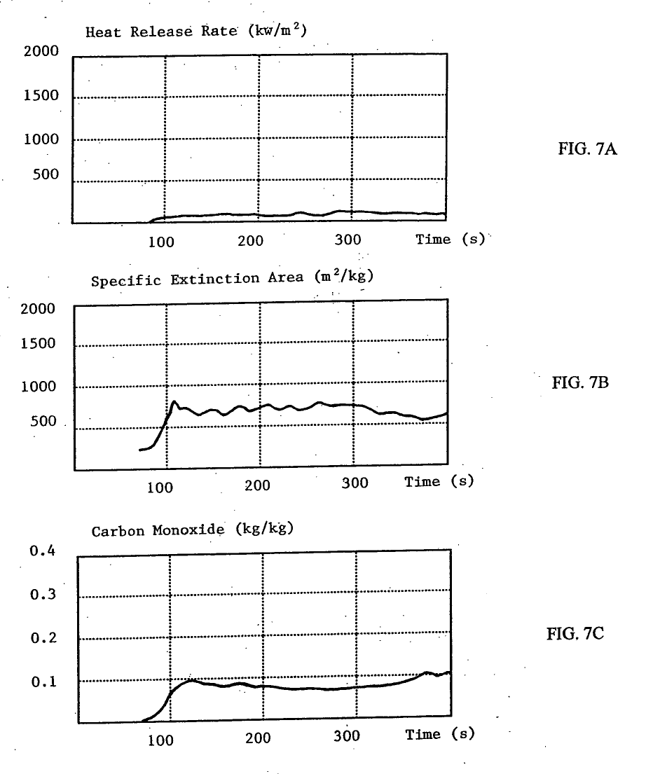

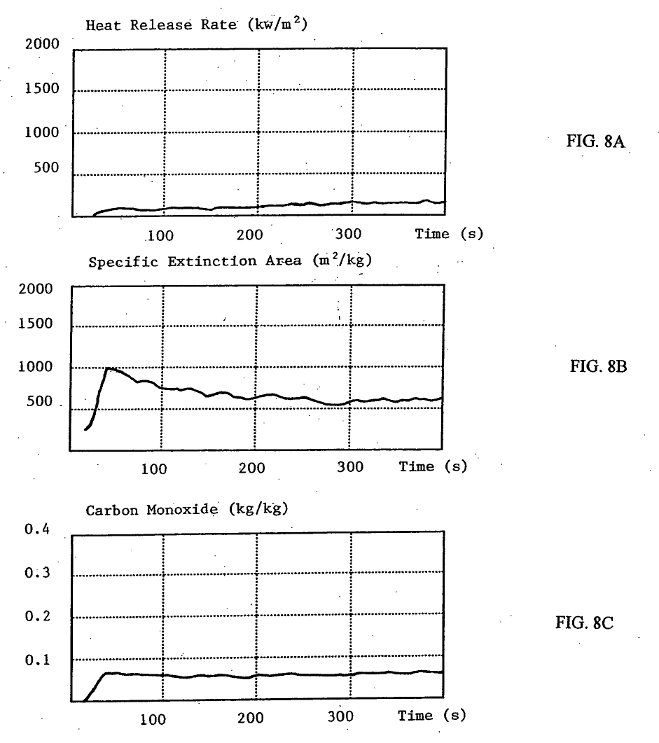

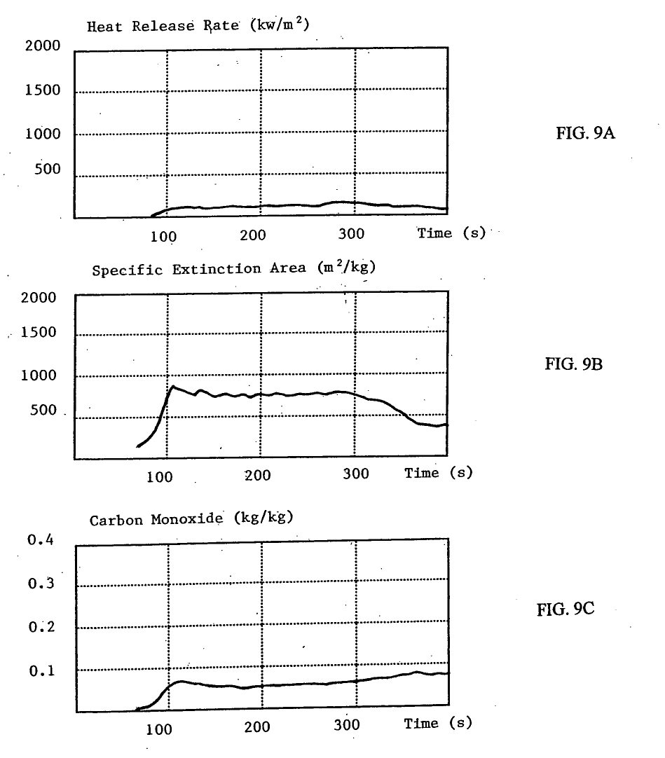

Performance test data relating to both the fire retardant and abrasion resistant character of the compositions of the subject invention, and several controls, are summarized in TABLE 1, Test Summary: Illustrative Formulation Composition vs. Controls. FIGS. 1-10 graphically illustrate select ASTM E 1354-90 test findings or properties, namely heat release, specific extinction area, and carbon monoxide, all as a function of time, for those select formulations of TABLE 1. Illustrative formulations for the tested anti-abrasive fire retardant composition of the subject invention are presented in TABLES 2-7, Illustrative Composition Formulations (ICF), more particularly, a summary of select or group test formulations from TABLE 1 is provided in TABLE 2, whereas TABLES 3-7 are each directed to specific later occurring formulations of TABLE 1. Finally, TABLE 8, Physical Properties, provides a listing of select physical properties for the specific later occurring compositions of TABLE 1, namely those formulations of TABLES 3-7, relative to ultrahigh molecular weight polyethylene.

As to the performance test parameters/methodologies utilized, ASTM D 2863-97 “Standard Test Method for Measuring the Minimum Oxygen Concentration to Support Candle-Like Combustion of Plastics (Oxygen Index),” incorporated herein by reference, covers a fire-test-response procedure and provides for the measuring of the minimum concentration of oxygen in a flowing mixture of oxygen and nitrogen that will just support flaming combustion of plastics.

ASTM E 1354-90 “Standard Test Method for Heat and Visible Smoke Release Rates from Materials and Products using an Oxygen Consumption Calorimeter,” incorporated herein by reference, provides for measuring the responsive materials exposed to controlled levels of radiant heating with or without an external igniter. This test method is used to determine the ignitability, heat release rates, mass loss rates, effective heat of combustion, and visible smoke development of materials and products. The rate of heat release is determined by measurement of the oxygen consumption as determined by the oxygen concentration and the flow rate in the exhaust products stream. The effective heat of combustion is determined from a concomitant measurement of specimen mass loss rate, in combination with the heat release rate. Smoke development is measured by obscuration of light by the combustion product stream. It is further noted that the rate of heat release is one of the most important variables, in many cases the single most variable, in determining the hazard from a fire.

For select illustrative formulation compositions summarized in TABLE 1 (i.e., formulation 1, 1C, 21, 21C, 22, and 22C) and controls (i.e., urethane 5.1, 5.2, and UHMWPE), select ASTM E 1354-90 results are provided in a graphic format in FIGS. 1-10. This particular method calls for use of a cone calorimeter. This state of the art fire test instrument was created by the national bureau of standards to measure, in scientific and engineering units, the flamability characteristics of materials. Its heating element, similar to that of an electric stove, is wound in a conical shape to produce a uniform heat flux across the surface of the sample being tested. The key properties it measures are: time to ignition, rate of heat release, and specific extinction area (i.e., smoke production).

Time to ignition is simply the time in seconds that the sample must be heated at a specific heat flux before it bursts into a flame. The heat flux (i.e., heat input into the sample) may be varied over a wide range, from 10-100 kilowatts per square meter. Higher heat fluxes typically give shorter times to ignition. Fire safety is improved by using materials with high (i.e., long) times to ignition.

Rate of heat release (RHR) is a measurement of how much heat a material produces once it is burning, and how fast the heat is evolved. Often the RHR changes as the material burns, increasing to a maximum once it “gets going” and then tapering off. The peak rate of heat release is the highest value obtained during the burn, and is considered by many fire scientists to be the most critical parameter to fire safety, as it answers the question “how big is the fire”. It is desirable to have a low peak RHR and to have the peak occur as late as possible in the burning process. A low average RHR is also desirable. The sum of the heat released by a material over the course of a burn is called the total heat released and is proportional to the average RHR. For illustration, consider a fluid ounce of gasoline and a charcoal briquet. In terms of total heat content they are about the same, roughly 950 BTU. But, since the gasoline has both the higher peak rate of heat release and a peak which occurs much sooner after ignition, it is much more dangerous than when burning the charcoal briquet. Obviously, gasoline also has a much shorter time to ignition, which makes it more problematic.

Specific extinction area (SEA) is the smoke measurement of the cone calorimeter. It represents the amount of smoke generated per kilogram of material burned, and is measured by recording the extinction of a laser beam shining through the exhaust duct (i.e., how much light is absorbed by the smoke). SEA is a critical material property since many fire deaths are caused by the inability of victims trapped in a burning building to find their way to safety through dense smoke, or the inability of the rescuers to find the victims. Low peak and average SEA values are highly desirably, especially in conjunction with a low RHR.

ASTM D 4060-95 “Standard Test Method for Abrasion Resistence of Organic Coatings by the Taber Abraser,” incorporated herein by reference, covers the termination of the resistence of organic coatings to abrasion produced by the Taber Abraser on coatings applied to a plain, rigid surface, such as a metal panel. The test method generally requires the organic material to be applied at a uniform thickness to a plain, ridged panel and, after curing, the surface is abraded by rotating the panel under weighted abrasive wheels. Abrasion resistence is then calculated as loss in weight at a specified number of abrasion cycles (i.e., loss in weight per cycle), or as a number of cycles required to remove a unit amount of coating thickness. With regard to the illustrative composition formulations (ICFs) summarized in TABLE 1, a H-18 wheel operating at 1000 cycles was utilized in performance of the ASTM D 4060 method.

Referring now to TABLE 1, the ICFs are identified as follows: 1, 1C, 21, 21C, 22, 22C, 37, 37C, RH FRP-800, RH FRP-700, RH FRP-800 HE, RH FRP-700 HE, and Ultraslide FRP 95. As previously noted, the formulation of each of these tested compositions are either summarized, TABLE 2, or separately presented herewith (TABLES 2-7).

The test compositions may be fairly categorized as comprising either a vinyl plastisol (e.g., ICFs. 1, 1C, 21, 21C, 22, 22C, 37, 37C) or as comprising a urethane elastomer system (e.g., RH FRP-800, RH FRP-700, RH FRP-800 HE, RH FRP-700 HE, and Ultraslide FRP 95). Preferably, each category of composition further includes at least a single fire retardant plasticizer (e.g., all ICFS but 1/1C), and may selectively include at least one metallic compound (e.g., ICFS 21/21C, or 22/22C), or expandable char forming graphite material (e.g., all urethane based ICFS).

Referring now to the vinyl plastisol based formulations, namely ICFS 1, 21, 22 and 37, along with those same organic formulations in combination with crushed ceramic, namely ICFS 1C, 21C, 22C and 37C, several comparative observations are noted with respect thereto.

First, ICFS 1 and 37 omit from the organic formulation the inorganic fire retardant additives aluminum trihydrate and zinc borate, with IFC 1 further omitting a fire retardant plasticizer, and IFC 37 omitting a secondary plasticizer from the composition.

Second, ICFS 21 and 22 have equivalent general compositions, however, each contain different fire retarding plasticizing agents, as noted.

Third, all composition designations include about approximately the same mass of PVC resin.

Fourth, the preferred compositions, as evidenced by the performance test results, is that of IFC 21/21C.

The ceramic constituent of the subject ICFS is on the order of about 50 to 70 wt % of the composition. The organic constituent is preferably a plastisol formulation comprising a PVC resin, ideally present in a quantity to comprise about 35 to 65 wt % of the composition. The formulation further includes a fire retardant plasticizer, preferably a phosphorous containing plasticizer, more particularly a 2-ethylhexyl diphenyl phosphate or a triaryl phosphate ester. As to the ceramic constituent, it preferably comprises Al₂O₃ particles having a thickness in the range of about 1/16 to ⅛ of an inch. Commercial embodiments of the composition may be backed with fabric, expanded metal or solid metal. Sheet materials are contemplated, with panels for instance being about four feet by ten feet and about ⅛ inch thick.

A preferred composition includes a PVC based resin which incorporates fire retardant additives, with a reduced amount of organic material being significantly off-set with the addition of ceramic elements or chips. As noted, the basic composition of the fire stop material includes approximately 35 wt % liquid organic binder material which functions to, among other things, hold the ceramic chips together (i.e., form a cohesive ceramic chip matrix). The liquid binder material may be one of several formulations as is supported by TABLE 2. The balance, approximately 65 wt %, are ceramic chips, which have been primed and coated with a prime to increase the adhesion between the organic liquid binder and the ceramic chips. Sheets of the basic composition include an expanded metal backing of 13-16 gauge flattened expanded metal, with openings from ⅛ to ½ inch. The expanded metal sheet may be washed, plasticized and primed to increase adhesion to the composite material. Although the fire stop sheet may be made into many different sizes and thicknesses, the most common size sheets are 4 feet wide by 10 feet long, or 5 feet wide by 10 feet long. Sheet thicknesses preferably can vary between ¼ to ½ inch, with thicker or thinner sheets possible, such parameter being application specific, and ultimately a matter of practicality.

As to the construction of fire stop sheeting or sheets utilizing the base composition, approximately ⅓ of the organic liquid binder material is poured onto a flat surface and is allowed to flow or spread in an even layer. The primed ceramic chips are distributed evenly throughout the mold surface. The balance of the organic liquid binder material is then distributed evenly over the ceramic chips, such that the binder material completely covers same. The expanded metal is then placed on top of the mix and is slightly submerged in the liquid binder material. A weight can be placed on top of the expanded metal to ensure intimate contact with the organic binder material. The composite material is then heated to approximately 400° F. until the composite is partially cured. At this stage a cure can be defined as a cure sufficient to allow the composite sheet to be lifted from the mold and placed in a jig for subsequent cure. The cure of the fire stop composite may be completed by one of the following three methods: (1) placing the pre-stage sheet in an air oven at approximately 450° F. for 15-30 minutes; (2) allowing the sheet to continue to cure on the heated table for approximately 30 minutes at 400° F.; or, (3) dip the staged composite sheet in molten salt at approximately 430° F. for up to 4 minutes.

For all its high marks relative to performance, formulations of this type are nonetheless far more difficult to work with for maintenance mechanics and fabricators when compared to known abrasion resistant sheets of pure urethane without ceramic chips. In the second category of composition of the subject invention, a 100% pure urethane elastomer is utilized, with or without ceramic chips, which substantially achieves the abrasion resistant characteristics of heretofore known non-modified urethane elastomers.

The urethane elastomer composition of the subject invention preferably but not necessarily includes a fire retardant phosphate ester plasticizer and an expandable charring/foaming graphite material. Although LOI and heat release data are presently unavailable for the subject ICFS, other performance test parameter values indicate attainment of the sought after threefold advantage, namely abrasion resistance, fire retardant character, and non-flowing quality when subjected to an open flame. Preferably, but not necessarily, the phosphate ester plasticizer and the charring graphite are present in equal proportion or relation, in the range of about 2-10 wt % each.

The fire retarding plasticizer reduces the flamability of the urethane elastomer and the expandable graphite material encapsulates the urethane composition in such a way that when flame impinges directly on the elastomer, it foams up but does not drip. The foam char prevents oxygen and/or heat from burning the urethane elastomer. Although the fire retardant plasticizer may be omitted (i.e., be 0 wt % of the composition), it is further advantageously included to assist in “thinning” a mixture comprising the combination of the urethane and the graphite. At some point, exclusive and or excessive addition of the graphite material to the mix leads to an increase in viscosity, a limiting handling criteria. Furthermore, underlying the nature of this formulation is the use of a reasonably fire resistant urethane elastomer to optimize the performance property of the overall formulation.

With general reference to TABLES 2-7, the ICFS generally comprise from about 25 wt % prepolymer (RH FRP-700) to about 50 wt % prepolymer (Ultraslide FRP 95), the prepolymer generally being a combination of isocyanate and polyols. The balance by weight is generally shown as being a curative, more particularly a mixture of designated polyol, 1, 4, butanediol, graphite material (e.g., UCAR 220-50N: GrafGuard™ grade 220-50 which is an intumescent graphite flake that begins to show significant expansion near 220° C.), and a phosphorous flame retardant (e.g., Reofos® 50/Sant 141).

It will be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

What is claimed is:

1. A composition of matter comprising an abrasion resistant urethane elastomer system including and effective amount of graphite.

2. The composition of claim 1 wherein said graphite is an intumescent graphite flake.

3. The composition of claim 2 wherein said intumescent graphite flake is expandable and char forming.

4. The composition of claim 3 wherein said intumescent graphite flake begins to show significant expansion near about 220° C.

5. The composition of claim 2 wherein said intumescent graphite flake comprises up to about 10 weight percent of said composition.

6. The composition of claim 6 wherein said fire retardant plasticizer comprises up to about 10 weight percent of said composition.

7. The composition of claim 6 wherein said fire retardant plasticizer and said intumescent graphite flake are present in said composition in equal parts by weight.

8. The composition of claim 5 wherein said fire retardant plasticizer comprises a phosphate ester.

9. The composition of claim 8 wherein said phosphate ester comprises a phosphorous content of about 7 percent by weight.

10. The composition of claim 8 further comprising 1, 4 butanediol.

11. The composition of claim 10 wherein said 1, 4 butanediol comprises about 2.5 to 8.5 weight percent of said composition.

12. The composition of claim 10 further comprising at least one metallic compound.

13. The composition of claim 12 wherein said at least one metallic compound is selected from the group consisting of aluminum trihydrate and zinc borate.

14. An anti-abrasive fire retardant composition comprising a polyvinyl chloride plastisol in combination with at least one metallic compound.

15. The anti-abrasive fire retardant composition of claim 14 wherein said at least one metallic compound comprises aluminum trihydrate.

16. The anti-abrasive fire retardant composition of claim 14 wherein said at least one metallic compound comprises a combination of aluminum trihydrate and zinc borate.

17. The anti-abrasive fire retardant composition of claim 15 wherein said aluminum trihydrate comprises up to about 9 weight percent of said composition.

18. The anti-abrasive fire retardant composition of claim 16 wherein said aluminum trihydrate comprises up to about 9 weight percent of said composition.

19. The anti-abrasive fire retardant composition of claim 18 wherein said zinc borate comprises up to about 5 weight percent of said composition.

20. The anti-abrasive fire retardant composition of claim 14 further comprising ceramic elements, said ceramic elements being on the order of about 50 to 70 weight percent of the composition.

21. The anti-abrasive fire retardant composition of claim 20 further comprising an effective amount of a fire retardant plasticizer.
